(19) United States
(12) Patent Application Publication
(10) Pub. No.: US 2021/0178457 A1
(43) Pub. Date: Jun. 17, 2021

(54) METALLIC SHEET SECUREMENT

(71) Applicant: Utica Enterprises, Inc., Troy, MI (US)

(72) Inventors: Mark A. SAVOY, Bloomfield Hills, MI (US); Phillip J. I. MORGAN, Royal Oak, MI (US)

(21) Appl. No.: 17/121,980

(22) Filed: Dec. 15, 2020

Related U.S. Application Data
(60) Provisional application No. 62/948,519, filed on Dec. 16, 2019.

(51) Int. Cl. B21J 5/06; B21K 25/00; B23P 19/06

(52) U.S. Cl. CPC B21J 5/066; F16B 25/0021; B23P 19/062; B21K 25/005

(57) ABSTRACT

A method and apparatus (20) provide light-safe heating of advanced high strength steel metallic sheet(s) (28 and/or 30) for securement of metallic sheets by flow fasteners (31).

### CROSS-REFERENCE TO RELATED APPLICATIONS

This application claims the benefit of U.S. provisional application Ser. No. 62/948,519 filed Dec. 16, 2019, the disclosure of which is hereby incorporated in its entirety by reference herein.

### TECHNICAL FIELD

Various embodiments relate to heating and securing of metallic sheets with fasteners.

### BACKGROUND

Pfeiffer et al., U.S. Pat. No. 9,901,974 B2 discloses an example for flow hole screw fastening of structural components.

### SUMMARY

According to at least one embodiment, a method for metallic sheet securement contacts a first metallic sheet and a second metallic sheet with each other with one of the metallic sheets being advanced high strength steel and having a joining location. A light-safe laser beam is projected upon, to thereby heat the joining location of the one metallic sheet. A flow fastener that is either a flow form screw or a flow push screw is inserted through the one metallic sheet at its heated joining location and also through the other metallic sheet to secure the metallic sheets to each other.

According to a further embodiment, both the first and second metallic sheets are advanced high strength steel. The light-safe laser beam impinges with the first metallic sheet and the flow fastener is initially inserted through the first metallic sheet and subsequently through the second metallic sheet to secure the metallic sheets to each other.

According to another further embodiment, the first metallic sheet is mild steel or aluminum and has a hole through which the light-safe laser beam is projected and through which the flow fastener is inserted. The second metallic sheet is advanced high strength steel and is heated by the light-safe laser beam and into which the flow fastener is inserted to secure the metallic sheets to each other.

According to another further embodiment, the first metallic sheet is advanced high strength steel and the second metallic sheet is mild steel or aluminum and is imperforate. The light-safe laser beam impinges with the first metallic sheet and the flow fastener is initially inserted through the first metallic sheet and subsequently through the second metallic sheet to secure the metallic sheets to each other.

According to another further embodiment, both the first and second metallic sheets are advanced high strength steel. The light-safe laser beam impinges with the second metallic sheet and the flow fastener is initially inserted through the first metallic sheet and subsequently through the second metallic sheet to secure the metallic sheets to each other.

According to another further embodiment, the first metallic sheet is mild steel or aluminum and is imperforate. The second metallic sheet is advanced high strength steel. The light-safe laser beam impinges with the second metallic sheet and the flow fastener is initially inserted through the first metallic sheet and subsequently through the second metallic sheet to secure the metallic sheets to each other.

According to another further embodiment, there are at least three metallic sheets in contact with each other and with the first metallic sheet and another one of the metallic sheets being advanced high strength steel and having outer surfaces facing outwardly in opposite directions to each other with aligned joining locations where light-safe laser beams projected in opposite directions respectively impinge to provide heating and through which the flow fastener is inserted to secure all of the metallic sheets to each other.

According to another embodiment, a heating and joining apparatus for metallic sheet securement is provided with tooling with a first end. A laser system is provided to selectively project a first light-safe laser beam from the first end of the tooling toward a workspace. A flow fastener driver is provided to supply flow fasteners of either a flow form screw type or a flow push screw type from the first end of the tooling to the workspace to secure metallic sheets to each within the workspace after heating of at least one of the metallic sheets, which is advanced high strength steel, within the workspace by the laser system. A controller is provided to operate the laser system and the flow fastener driver in coordination with each other to provide the securement of the metallic sheets to each other.

According to a further embodiment, the controller selectively operates the laser system to supply the first light-safe laser beam to provide the heating.

According to another further embodiment, a robot is provided to move the tooling to selected locations to perform the metallic sheet heating and joining.

According to another embodiment, an assembly is provided with at least one sheet of advanced high strength steel (AHSS) and a second metallic sheet. A flow fastener is fastened to the at least one sheet of AHSS and the second metallic sheet.

According to a further embodiment, the AHSS has a tensile strength of at least 980 megapascals.

According to another further embodiment, the flow fastener is provided as a flow form screw or a flow push screw.

### BRIEF DESCRIPTION OF THE DRAWINGS

FIG. 1 is a side elevation view of an apparatus to provide metallic sheet securement according to an embodiment;

FIG. 2a is a side section view of metallic sheet securement with a laser according to an embodiment;

FIG. 2b is a side section view of the metallic sheet securement of FIG. 2a with a flow fastener according to an embodiment;

FIG. 3a is a side section view of metallic sheet securement with a laser according to an embodiment;

FIG. 3b is a side section view of the metallic sheet securement of FIG. 3a with a flow fastener according to an embodiment;

FIG. 4a is a side section view of metallic sheet securement with a laser according to an embodiment;

FIG. 4b is a side section view of the metallic sheet securement of FIG. 4a with a flow fastener according to an embodiment;

FIG. 5a is a side section view of metallic sheet securement with a laser according to an embodiment;

FIG. 5b is a side section view of the metallic sheet securement of FIG. 5a with a flow fastener according to an embodiment;

FIG. 6a is a side section view of metallic sheet securement with a laser according to an embodiment;

FIG. 6b is a side section view of the metallic sheet securement of FIG. 6a with a flow fastener according to an embodiment;

FIG. 7a is a side section view of metallic sheet securement with a laser according to an embodiment;

FIG. 7b is a side section view of the metallic sheet securement of FIG. 7a with a flow fastener according to an embodiment;

FIG. 8a is a side section view of metallic sheet securement with a laser according to an embodiment;

FIG. 8b is a side section view of the metallic sheet securement of FIG. 8a with a flow fastener according to an embodiment;

FIG. 9 is a side perspective view of a flow fastener according to an embodiment;

FIG. 10 is a side perspective view of a flow fastener according to another embodiment;

FIG. 11 is a partial front elevation view of a flow fastener driver of the apparatus of FIG. 1;

FIG. 12 is a partial right side elevation view of the flow fastener driver of FIG. 11;

FIG. 13 is a partial left side elevation view of the flow fastener driver of FIG. 11;

FIG. 14 is a top view of the flow fastener driver of FIG. 11;

FIG. 15 is a front elevation view of the flow fastener driver of FIG. 11;

FIG. 16 is a left side elevation view of a tooling assembly of the apparatus of FIG. 1 according to an embodiment;

FIG. 17 is front elevation view of the tooling assembly of FIG. 16;

FIG. 18 is a left side elevation view of a tooling assembly of the apparatus of FIG. 1 according to another embodiment, illustrated in a raised position;

FIG. 19 is a left side elevation view of the tooling assembly of FIG. 18, illustrated in a lowered position;

FIG. 20 is a front elevation view of the tooling assembly of FIG. 18;

FIG. 21 is a partial front, side perspective view of a light-safe guard assembly of the tooling assemblies FIGS. 16-20, according to an embodiment, illustrated in an open position;

FIG. 22 is a front, perspective view of the light-safe guard assembly of FIG. 21, illustrated in the open position;

FIG. 23 is a front, perspective view of the light-safe guard assembly of FIG. 21, illustrated in a closed position;

FIG. 24 is a right side perspective view of the light-safe guard assembly of FIG. 21, illustrated in the closed position;

FIG. 25 is a bottom view of the light-safe guard assembly of FIG. 21, illustrated in the closed position;

FIG. 26 is a bottom view of the light-safe guard assembly of FIG. 21, illustrated in the open position;

FIG. 27 is a partial front perspective view of the tooling assembly of FIG. 18, illustrating the light-safe guard assembly of FIG. 1 in the closed position; and

FIG. 28 is a side perspective section view of metallic securement with a flow fastener according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

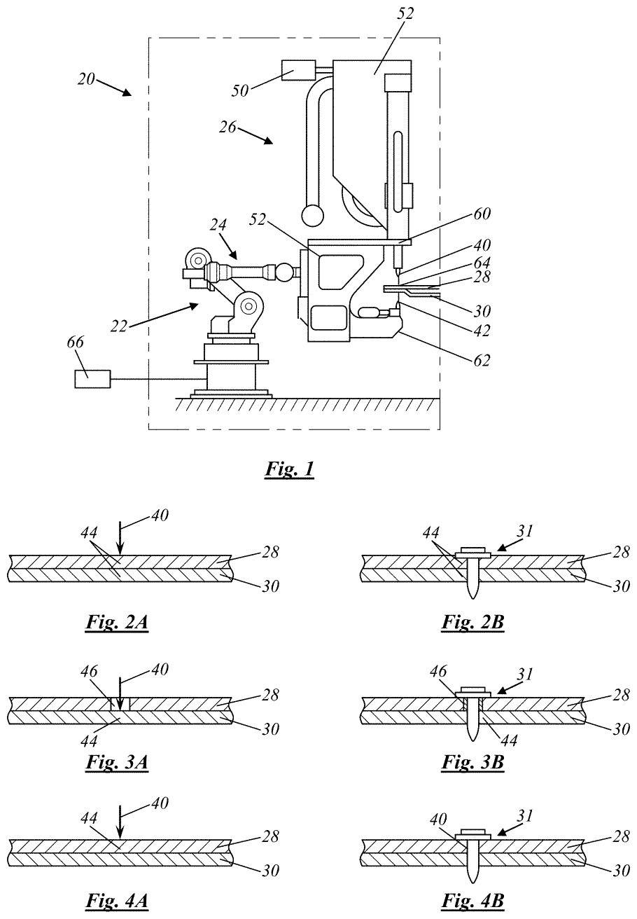

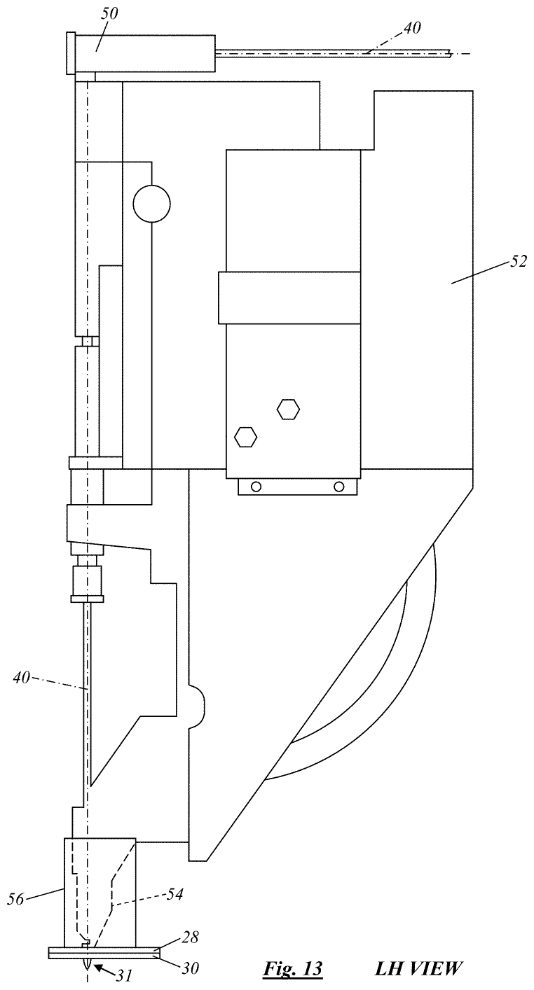

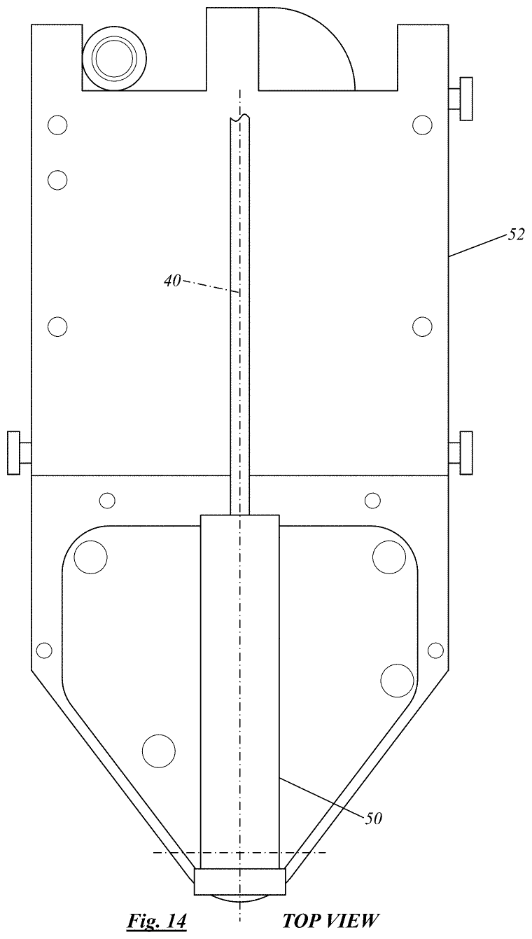

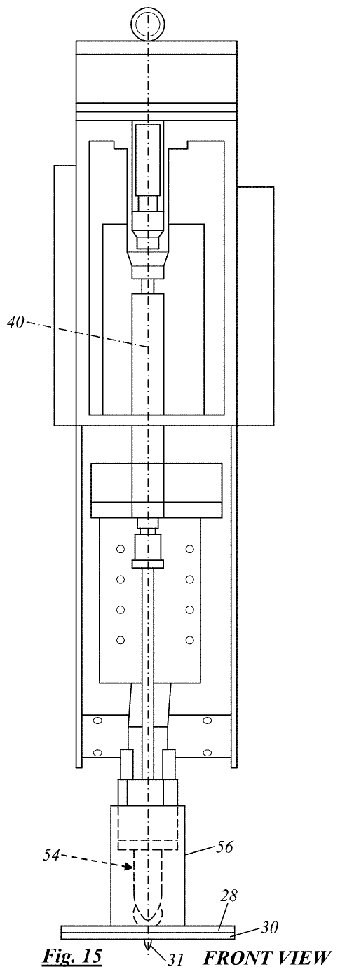

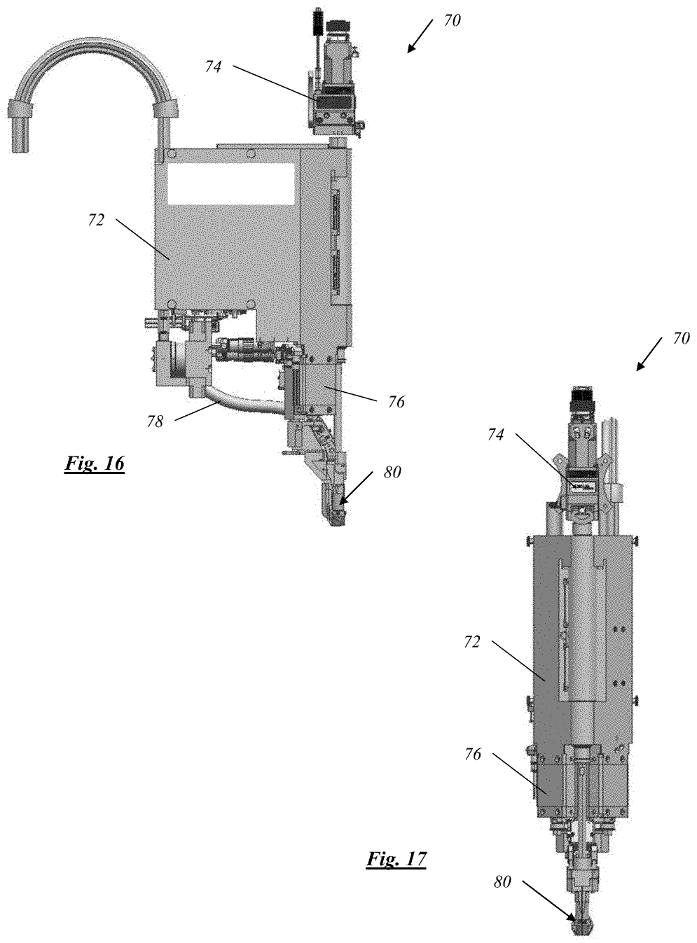

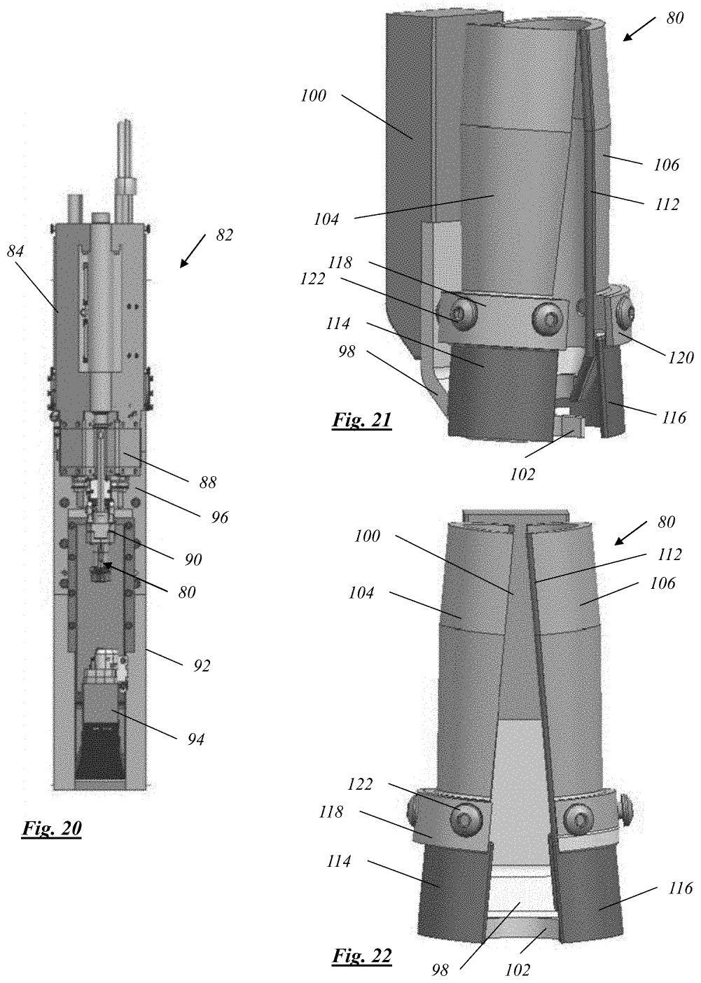

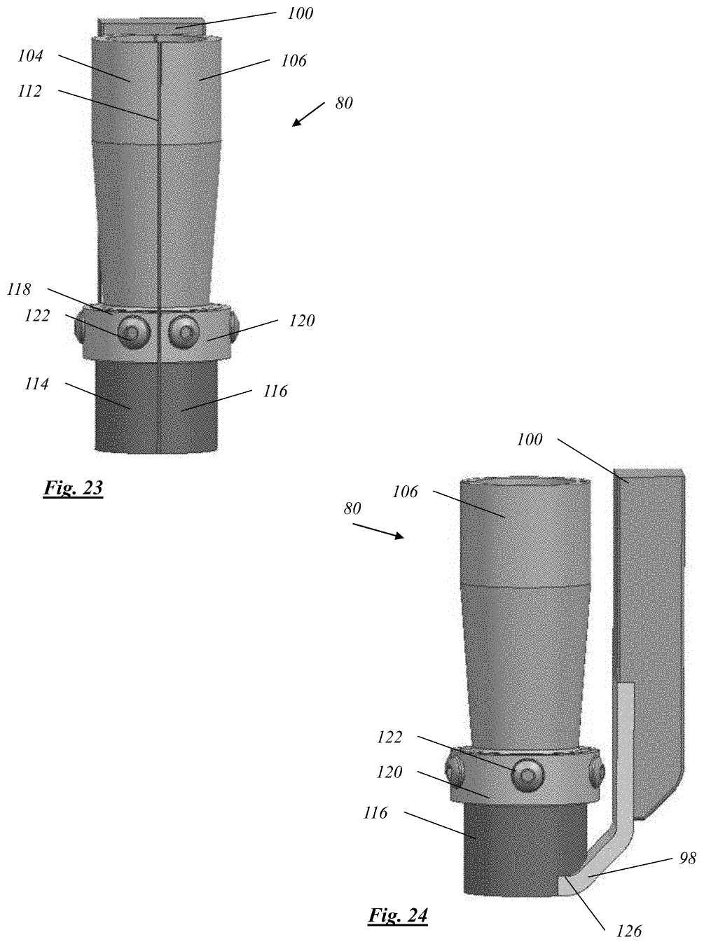

An apparatus is generally indicated by 20 and illustrated in FIGS. 1 and 11-27 to provide metallic sheet securement as also illustrated by FIGS. 2a and 2b, 3a and 3b, 4a and 4b, 5a and 5b, 6a and 6b, 7a and 7b, 8a and 8b, 9, 10, and 28. Both the apparatus and method of various embodiments is described below in an integrated manner to facilitate an understanding of various features.

Advanced high strength steel (AHSS) involved with the securement of metallic sheets according to an embodiment has a tensile strength of 700 megapascals up to 2,000 megapascals (A/Pa) or more. As such, advanced high strength steel sheets have particular utility for use in vehicle body manufacturing such as with underbody components, side components, roof pillars, and roof constructions with a relatively thin gauge and thus lightweight construction that enhances vehicle fuel efficiency while still having structural strength. However, such advanced high strength steel sheets are hard and not sufficiently ductile for forming. Additionally, these advanced high strength steel sheets are too hard to be drilled and tapped by conventional machining. For example, installation of a flow fastener into materials with a tensile strength over 980 megapascals causes failures to the fasteners.

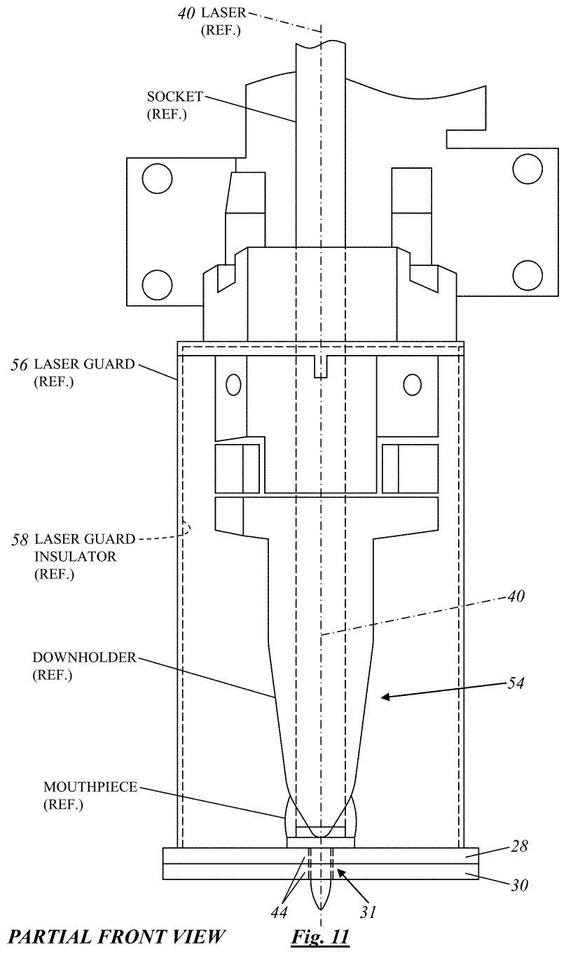

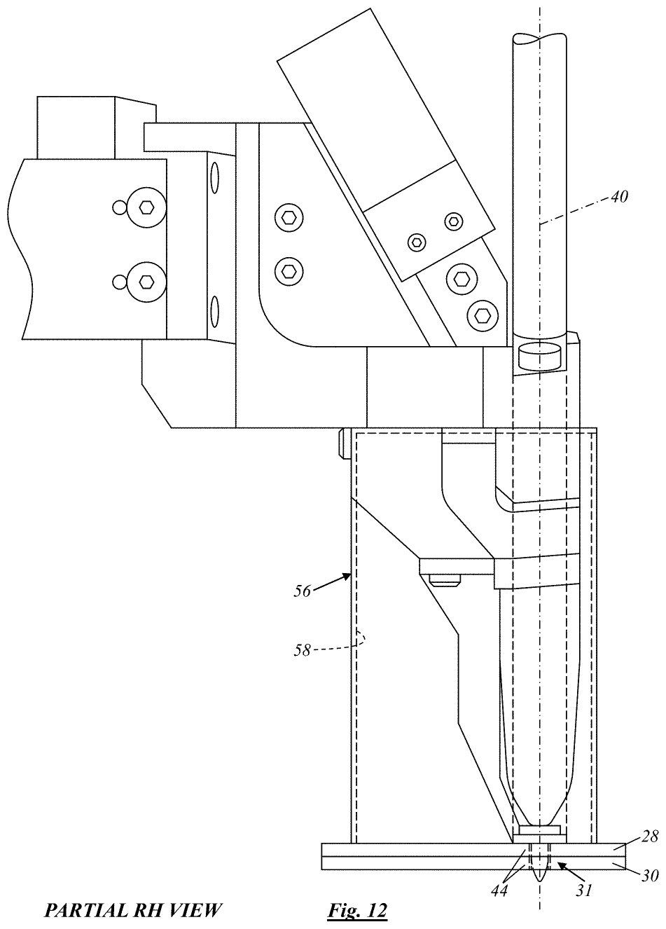

As illustrated in FIG. 1, a robot, generally indicated by 22, includes a movable arm 24 that supports a laser system 26 for securing a first metallic sheet 28 and a second metallic sheet 30, at least one of which is made of advanced high strength steel. The securement is by flow fasteners 31 which may be either a flow form screw 32 as shown in FIG. 9 with helical threads 34 that allow unthreading of the screw, or a flow push screw 36 as shown in FIG. 10 with round rings 38 that provide a fastener that cannot be removed by unthreading after securement as is hereinafter described. Of course, any flow fastener may be employed. The prior art has installed flow fasteners by applying torque and pressure to the fastener to heat the workpiece through friction, and consequently to pierce and fasten the fastener to the workpiece.

The laser system 26 is constructed to selectively provide either a downwardly projected light-safe laser beam 40 as is hereinafter described in connection with FIGS. 11-15 or to selectively provide an upwardly directed light-safe laser beam 42 in the manner provided by Savoy et al., U.S. Pat. No. 9,815,109 B2, which issued to Utica Enterprises, Inc., on Nov. 14, 2017, the entire disclosure of which is hereby incorporated by reference. For versatility, only the downwardly projected light-safe laser beam 40 may be provided, only the upwardly directed light-safe beam 42 may be provided, or both the downwardly and upwardly directed light-safe laser beams 40 and 42 may be provided, depending upon metallic sheets being secured to each other. The laser beams 40 and 42 may be employed to heat materials with high tensile strengths, whereby friction heating is insufficient to pierce, tap and/or fasten the fastener.

Each of the FIGS. 2-8 with the subscript “a” illustrates the manner in which laser heating is performed by one or more associated light-safe laser beams and each of the FIGS. 2-8 with a subscript “b” illustrates the manner in which one of the flow fasteners 31 illustrated in FIGS. 9 and 10 secures the metallic sheets after the light-safe laser heating.

With reference to FIG. 2a, first and second metallic sheets 28 and 30 of advanced high strength steel each have a joining location 44 that is heated by a downwardly directed light-safe laser beam 40 for securement by a flow fastener 31 as shown in FIG. 2b.

In FIG. 3a, the metallic sheet 28 has a hole 46 through which the downwardly projected light-safe laser beam 40 heats the joining location 44 of the metallic sheet 30 of advanced high strength steel to permit the flow fastener 31 to secure the two metallic sheets to each other as shown in FIG. 3b.

In FIG. 4a, the metallic sheet 28 is advanced high strength steel with the joining location 44 that is heated by a downwardly directed light-safe laser beam 40 while the metallic sheet 30 is mild steel or aluminum which may or may not be heated to a limited extent by the laser beam passing through the metallic sheet 28 while still permitting securement of the two metallic sheets to each other by the flow fastener 31 shown in FIG. 4b.

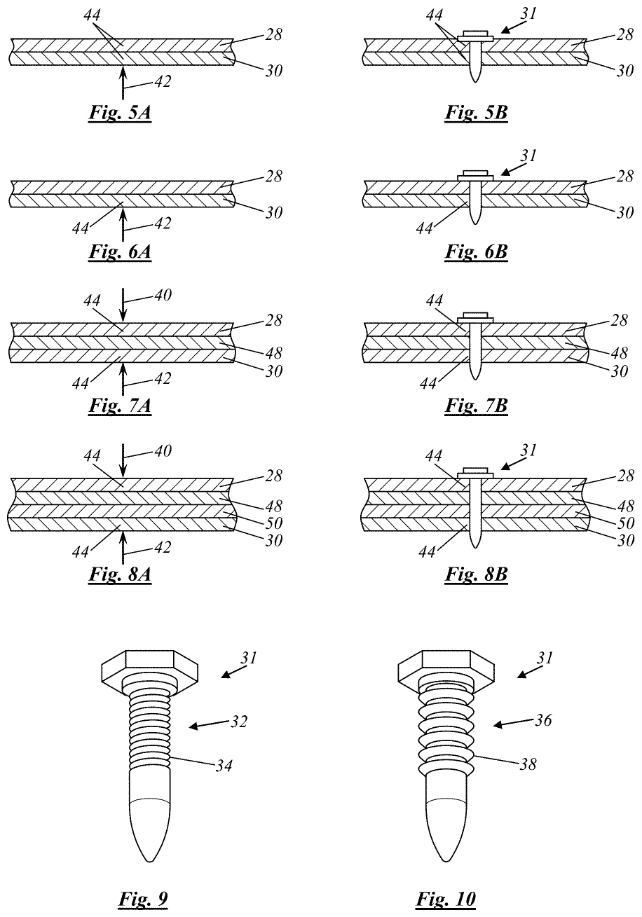

In FIG. 5a, both the metallic sheet 28 and the metallic sheet 30 are advanced high strength steel whose joining locations 44 are both heated by an upwardly directed light-safe laser beam 42 in order to permit the flow fastener 31 to provide the securement shown in FIG. 5b.

In FIG. 6a, the metallic sheet 28 is mild steel or aluminum and is imperforate while the metallic sheet 30 is advanced high strength steel whose joining location 44 is heated by the upwardly directed light-safe laser beam 42 in order to permit the securement of these metallic sheets by the flow fastener 31 shown in FIG. 6b.

FIGS. 7a and 8a illustrate how three or more of the metallic sheets 28 and 30 of advanced high strength steel are heated by the downwardly and upwardly directed light-safe laser beams 40 and 42 with additional sandwiched metallic layers 48 and 50, etc. between the outer layers so as to permit the securement by the flow fasteners 31 as illustrated in FIGS. 7b and 8b. The intermediate metallic sheet(s) 48 and/or 50 may be mild steel, aluminum, advanced high strength steel or combinations of these three metals.

The laser system 26 shown in FIG. 1 has a laser collimator 50 for projecting laser beam 40 through a light-safe path of a housing 52 and the housing also supplies the flow fasteners 31 previously described by the structure indicated in FIGS. 11-15 for the metallic sheet securement after the laser heating as described above. The structure involved includes a flow fastener driver 54 that provides insertion by rotation and/or pushing of the flow fasteners 31 in a cyclical manner with operation of the robot 22 moving the laser system 26 on the robot arm 24 to different locations for the sheet metal securement. A laser guard 56 including an insulator 58 has a downwardly opening shape that contacts to upper most metallic sheet 28 to contain the laser beam 40. A suitable sensor senses for such contact and only permits projection of the laser beam upon the contact to provide the light-safe operation.

The housing 52 of laser system 26 is C-shaped with a first end 60 and a second end 62 that are spaced from each other as shown in FIG. 1 to define a workspace 64 in which the light-safe laser heating and metallic sheet securement is performed.

A controller 66 shown in FIG. 1 operates the robot 22 to control all of its movements and operations including only permitting the laser beams 40 and/or 42 to be projected when there is a light-safe contact of the laser system with the metallic sheet(s) 28 and/or 30 is sensed so no laser beam can escape.

FIGS. 16 and 17 illustrate an end effector 70 according to another embodiment. The end effector 70 includes a housing 72. The housing 72 is sized to be mounted to equipment for presentation to a workpiece. For example, the end effector 70 may be mounted to equipment for automation to present a workpiece to the end effector 70. Likewise, the supportive equipment may also be automated to engage and operate upon the workpiece. Akin to prior embodiments, the end effector 70 may be employed as a robotic end of arm tooling mounted to the arm of a multiple axis flexible automation robot for programmable automation of operation on various workpieces at various orientations.

The end effector 70 includes a collimator 74 for heating a workpiece with a laser in order to soften the surface of the workpiece before introduction of a flow screw. The end effector 70 also includes a driver 76. The driver 76 is employed to push and translate, while rotating with torque, flow form screws 32 into workpieces. The driver 76 is also employed to push and translate flow push screws 36 into workpieces. Alternatively, the collimator 74 may be angled to share a target work location with the driver 76 to heat and fasten a common surface of the workpiece, as illustrated in the next embodiment. The collimator 74 and the driver 76 can be utilized to operate on a top surface of the workpiece according to one example. By approaching and fastening a top surface only of a workpiece, the end effector 70 can reach various locations where a top and bottom approach may not both be accessible. The end effector 70 also includes a feed system 78 with a guide and feed tube to intermittently and sequentially deliver fasteners to the driver 76 for repeated fastening operations. The feed system 78 is controlled to time the delivery of a fastener such that the fastener can be delivered to the workpiece immediately after the heating of the workpiece in order to install the fastener while the workpiece is still heated, and to increase productivity.

The end effector 70 also includes a light-safe guard assembly 80 to contain the laser during the heating process. Fastener securement in various high strength metal applications often presents a workpiece with a contoured shape and often has various obstacles. Therefore, providing the end effector 70 with compact tooling due the coordinated collimator 74 and the driver 76 with the compact guard assembly 80 permits the end effector 70 to install fasteners 32, 36 at various locations. The light-safe guard assembly 80 is illustrated and described in greater detail below in FIGS. 21-27.

The end effector 70 is effective for installing the fasteners 32, 36 to multiple sheets of material when the top surface is an AHSS material that requires heating before installation, and the underlying layer is a soft material. The end effector 70 can also be employed to heat a soft metal top layer and an AHSS underlying layer. The end effector 70 can also heat an underlying AHSS layer through a clearance hole formed in one or more upper layers. Multiple AHSS layers can be fastened together by providing clearance apertures in one or more upper AHSS layers.

FIGS. 18-20 illustrate an end effector 82 according to another embodiment. The end effector 82 includes an upper housing 84 for mounting the end effector 82 to equipment, such as a robot. The end effector 82 includes an upper collimator 86 for heating an upper workpiece similar to the prior embodiment. The end effector 82 also includes a driver 88 for driving the fasteners 32, 36 into workpieces. The collimator 86 is angled to share a target work location with the driver 88 to heat and fasten a common surface of the workpiece. The end effector 82 also includes a feed system 90 with a guide and feed tube to intermittently and sequentially deliver fasteners to the driver 88. The end effector 82 also includes a light-safe guard assembly 80 to contain the laser during the heating process.

The end effector 82 includes a lower housing 92 that supports a lower collimator 94 to heat a lower workpiece with a laser for installation of the fastener 32, 36 from the driver 88. The lower collimator may be provided with a laser collimator 94 as disclosed in Savoy et al., U.S. Pat. No. 9,815,109 B2, which issued to Utica Enterprises, Inc., on Nov. 14, 2017, the disclosure of which is incorporated by reference.

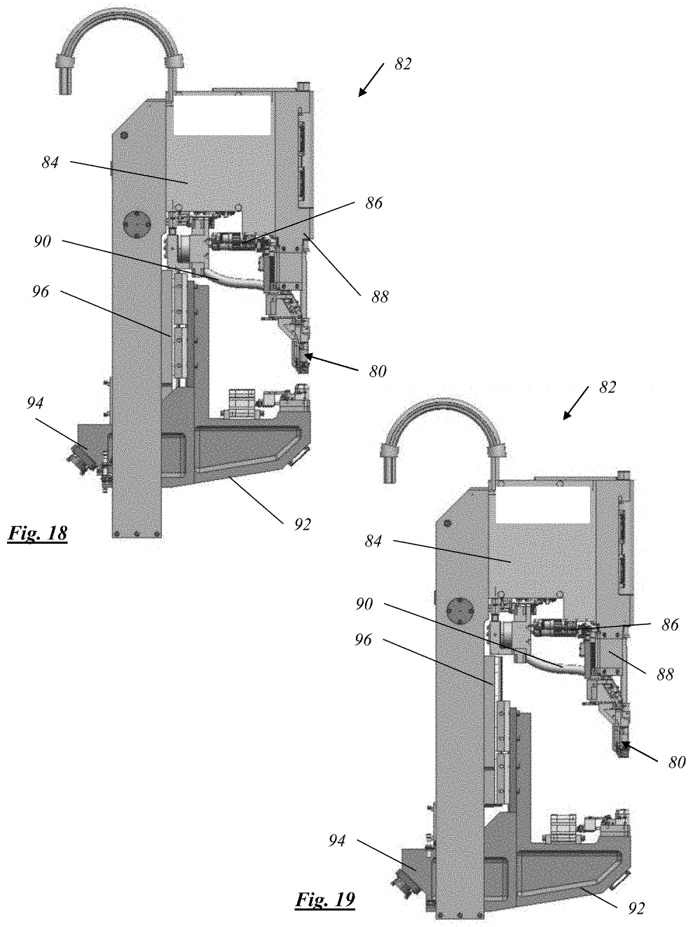

The upper housing 84 and the lower housing 92 include distal ends to operate on the workpieces, which are spaced apart from each other and facing each other to operate on aligned upper and lower surfaces of the workpieces. The lower housing 92 is connected to the upper housing 84 upon a track 96 which includes a guide and a linear actuator for translation of the lower housing 92 relative to the upper housing 84. A raised position of the lower housing 92 is depicted in FIG. 18; and a lowered position of the lower housing 92 is depicted in FIG. 19. Translation of the lower housing 92 accommodates workpieces of varying thicknesses and combinations of workpieces of varying thicknesses. Additionally, a workpiece may employ a fastener adjacent to an obstacle, such as a bend in the sheet metal, whereby the lower housing 92 may be lowered for clearance at approach, raised for operation, and lowered again for clearance while retracting the tooling.

The end effector 82 permits the fasteners 32, 36 to be driven into multiple sheets of AHSS by heating upper and lower sheets prior to installation of the fasteners. Alternatively, if only a lower sheet is AHSS, then the upper collimator 86 may be unused, or omitted altogether.

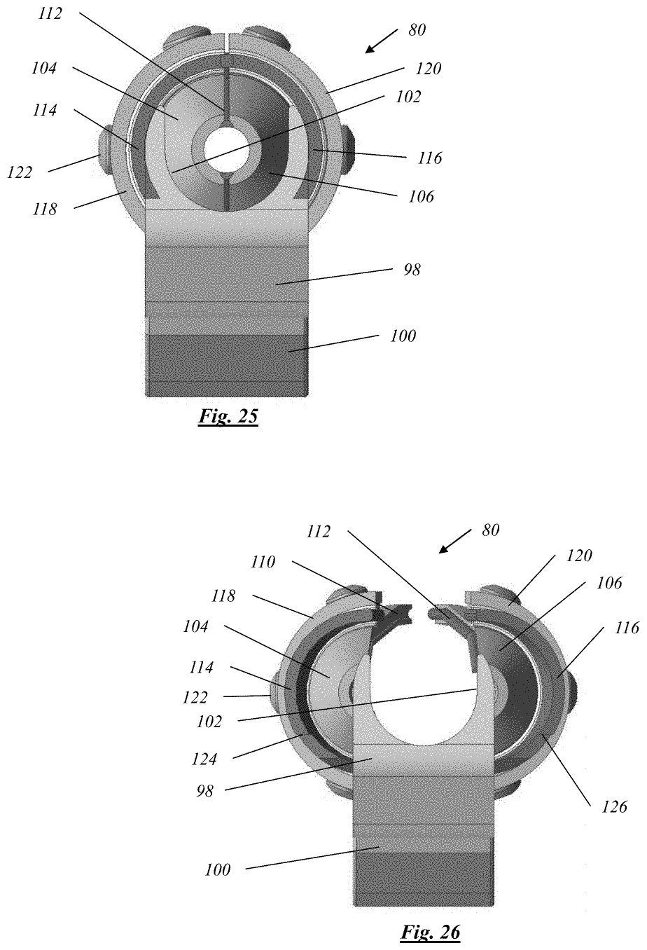

FIGS. 21-27 illustrate the light-safe guard assembly 80 in greater detail. The light-safe guard assembly 80 includes a contact foot 98 mounted to a bracket 100 on the upper housing 84. The contact foot 98 extends below the upper housing 84 and contacts the workpiece to apply a pressure to the workpiece to maintain a position of the workpiece during the fastening operation. For example, the contact foot 98 prevents the fastening operation from separating the material sheets from one another during the fastening operation so that a gap is not created within the workpiece. As depicted in the bottom axial end views of FIGS. 25 and 26, the contact foot 98 include a recess 102 to provide clearance at a heating and fastening location upon the workpiece.

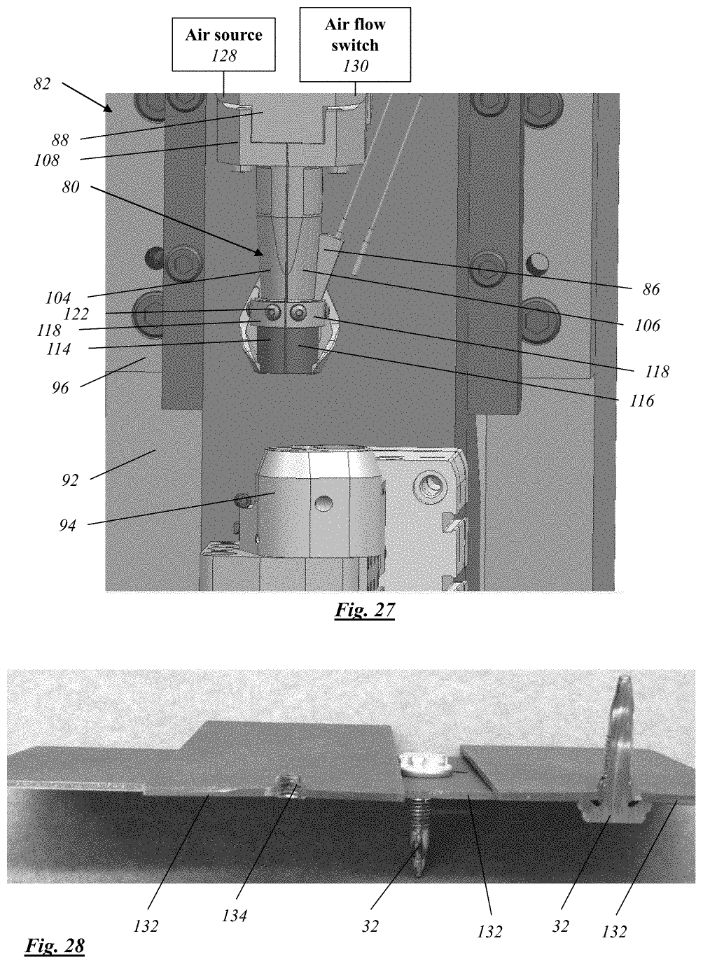

The light-safe guard assembly 80 includes a pair of elongate shroud portions 104, 106 to enclose the work location of the workpieces. The shroud portions 104, 106 are round and partially tapered and each meet at a lengthwise bisection of a collectively round and hollow cross section. As illustrated in FIG. 27, the shroud portions 104, 106 are mounted to an actuator 108 for pivoting between an open position depicted in FIGS. 21, 22 and 26, to a closed position depicted in FIGS. 23-25 and 27.

The light-safe guard assembly 80 approaches the work location of the workpieces in the open position (FIGS. 21, 22 and 26) of the shroud portions 104, 106. Once the foot 98 contacts the workpiece, the upper housing 84 is maintained in position, and the actuator 108 closes the shroud portions 104, 106. The shroud portions 104, 106 contribute to a light-safe enclosure. Referring to FIG. 26, a groove 110 is formed along the bisection line of one of the shroud portions 104. A seal, such as a gasket 112 is provided along the bisection line of the other shroud portion 106. Once the shroud portions 104, 106 are closed (FIGS. 23-25 and 27), the gaskets 112 engage the grooves 110 and seal the shroud portions 104, 106 lengthwise.

The light-safe guard assembly 80 includes a pair of arcuate arrays of wire bristles 114, 116. Each array 114, 116 includes multiple layers of bristles about concentric arcs. The arrays of bristles 114, 116 are each mounted to one of the shroud portions 104, 106 by a half collar 118, 120. Each half collar 118, 120 is fastened to a distal end of the corresponding shroud portion 104, 106 by screws 122 to clamp a proximal end of the bristle array 114, 116 to the corresponding shroud portion 104, 106. The bristle arrays 114, 116 include recesses 124, 126 for clearance of the contact foot 98 as illustrated in FIG. 26. The bristle arrays 114, 116 engage the workpiece to provide a flexible contact with the workpiece that is light-safe to contain the laser, while sufficiently flexible to avoid damage to the workpiece.

Referring now to FIG. 27, an air source line 128 delivers a pressurized air source into an enclosed chamber provided within the shroud portions 104, 106 and the bristle arrays 114, 116. An air flow switch 130 measures the air flow or pressure within the work chamber. Once the shroud portions 104, 106 are closed, if there is no change in air pressure, then the work chamber is airtight, and consequently light=safe. Based on this condition, the collimator 86 is operated to heat the workpiece. Likewise, if a lower pressure is detected or a continuous air flow is detected, then an air leak is detected, which could potentially permit a breach in light safety. In this detected condition, the collimator 86 is not operated to maintain light safety at the workpiece.

FIG. 28 illustrates a plurality of flow form screws 32 installed into workpieces 132. One of the workpieces 132 is illustrated with a flow form screw 32 removed, thereby demonstrating a resultant threaded aperture 134 that is formed into the workpiece 132 as the workpiece 132 cools. Therefore, the flow form screw 32 can be removed for repair and replacement of components that are installed and/assembled with flow form screws 32.

While various embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for metallic sheet securement comprising:
contacting a first metallic sheet and a second metallic sheet with each other with one of the metallic sheets being advanced high strength steel and having a joining location;
projecting a light-safe laser beam upon, to thereby heat the joining location of the one metallic sheet; and
inserting a flow fastener that is either a flow form screw or a flow push screw through the one metallic sheet at its heated joining location and also through the other metallic sheet to secure the metallic sheets to each other.

2. The method for metallic sheet securement as in claim 1 wherein both the first and second metallic sheets is advanced high strength steel, and wherein the light-safe laser beam impinges with the first metallic sheet and the flow fastener is initially inserted through the first metallic sheet and subsequently through the second metallic sheet to secure the metallic sheets to each other.

3. The method for metallic sheet securement as in claim 1 wherein the first metallic sheet is mild steel or aluminum and has a hole through which the light-safe laser beam is projected and through which the flow fastener is inserted, and wherein the second metallic sheet is advanced high strength steel and is heated by the light-safe laser beam and into which the flow fastener is inserted to secure the metallic sheets to each other.

4. The method for metallic sheet securement as in claim 1 wherein the first metallic sheet is advanced high strength steel and the second metallic sheet is mild steel or aluminum and is imperforate, and wherein the light-safe laser beam impinges with the first metallic sheet and the flow fastener is initially inserted through the first metallic sheet and subsequently through the second metallic sheet to secure the metallic sheets to each other.

5. The method for metallic sheet securement as in claim 1 wherein both the first and second metallic sheets is advanced high strength steel, and wherein the light-safe laser beam impinges with the second metallic sheet and the flow fastener is initially inserted through the first metallic sheet and subsequently through the second metallic sheet to secure the metallic sheets to each other.

6. The method for metallic sheet securement as in claim 1 wherein the first metallic sheet is mild steel or aluminum and is imperforate and wherein the second metallic sheet is advanced high strength steel, and wherein the light-safe laser beam impinges with the second metallic sheet and the flow fastener is initially inserted through the first metallic sheet and subsequently through the second metallic sheet to secure the metallic sheets to each other.

7. The method for metallic sheet securement as in claim 1 wherein there are at least three metallic sheets in contact with each other and with the first metallic sheet and another one of the metallic sheets being advanced high strength steel and having outer surfaces facing outwardly in opposite directions to each other with aligned joining locations where light-safe laser beams projected in opposite directions respectively impinge to provide heating and through which the flow fastener is inserted to secure all of the metallic sheets to each other.

8. A heating and joining apparatus for metallic sheet securement comprising:
tooling with a first end;
a laser system to selectively project a first light-safe laser beam from the first end of the tooling toward a workspace; and
a flow fastener driver to supply flow fasteners of either a flow form screw type or a flow push screw type from the first end of the tooling to the workspace to secure metallic sheets to each within the workspace after heating of at least one of the metallic sheets, which is advanced high strength steel, within the workspace by the laser system; and
a controller to operate the laser system and the flow fastener driver in coordination with each other to provide the securement of the metallic sheets to each other.

9. The heating and joining apparatus for metallic sheet securement as in claim 8 wherein the controller selectively operates the laser system to supply the first light-safe laser beam to provide the heating.

10. The heating and joining apparatus for metallic sheet securement as in claim 9 further comprising a robot to move the tooling to selected locations to perform the metallic sheet heating and joining.

11. An assembly comprising:
at least one sheet of advanced high strength steel (AHSS);
a second metallic sheet; and
a flow fastener fastened to the at least one sheet of AHSS and the second metallic sheet.

12. The assembly of claim 11 wherein the AHSS has a tensile strength of at least 980 megapascals.

13. The assembly of claim 11 wherein the flow fastener comprises a flow form screw or a flow push screw.
